(19) United States
(12) Patent Application Publication
(10) Pub. No.: US 2011/0220431 A1
(43) Pub. Date: Sep. 15, 2011

(54) PERSONNEL CARRIER FOR STANDING OCCUPANT

(75) Inventor: ARTHUR WANG, KAOHSIUNG COUNTY (TW)

(73) Assignee: FREERIDER CORP., KAOHSIUNG COUNTY (TW)

(21) Appl. No.: 12/722,821

(22) Filed: Mar. 12, 2010

(51) Int. Cl. B60K 17/30

(52) U.S. Cl. 180/252

(57) ABSTRACT

A personnel carrier for standing occupant is provided, comprising a handle portion, a bearing portion, a power supply portion and a drive portion. The handle portion has a support section, a steering handle, a front wheel and a forward-reverse manipulation unit. The bearing portion having a bearing stage is pivotally coupled with the handle portion, two rear wheels being attached to the bearing stage. The power supply portion is mounted on the support section of the handle portion. The drive portion incorporated with an electromagnetic brake device is disposed in the front wheel to control advance or stop of the personnel carrier. In this manner, a compact personnel carrier for bearing personnel in standing manner is thus formed.

### BACKGROUND OF THE INVENTION

1. Field of the Invention

The present invention relates to a personnel carrier for standing occupant, more particularly to a novel design of compact personnel carrier for standing occupant.

2. Brief Description of the Prior Art

Comparing to ordinary motorcycle, electric scooter has advantages of environmental friendliness, low energy consumption and easy manipulation. Moreover, electric scooter has neither waste gas exhaust nor noise produced in driving; hence it becomes more and more popular especially in indoor transportation of public space such as airport, shopping mall or in community. Up to now, the structure of electric scooter and its component have been well developed step by step along with the improvement endeavored on it by relevant industries involved. However, in an ordinary electric scooter for seated occupant, seats for users have to be provided such that the whole configuration looks so bulky.

### SUMMARY OF INVENTION

In view of the abovementioned disadvantages, the inventor of the present invention has proposed a compact personnel carrier for bearing user in standing manner such that seat is no more needed. Therefore, space can be saved so as to widen the view for user.

In order to achieve above object, this invention provides a personnel carrier for standing occupant, comprising a handle portion, a bearing portion, a power supply portion and a drive portion. The handle portion has a support section, a steering handle located on the top end of the support section, a front wheel installed on the lower end of the support section and a forward-reverse manipulation unit provided beneath the direction manipulating terminal. The bearing portion having a bearing stage for standing occupant is pivotally coupled with the handle portion, two rear wheels being attached to the bearing stage. The power supply portion is mounted on the support section of the handle portion. The drive portion incorporated with an electromagnetic brake device is disposed in the front wheel so as to control advance or stop of the personnel carrier. In this manner, a compact personnel carrier for bearing personnel in standing manner is thus formed.

According to the present invention, the power supply portion utilizes lithium battery as the power means for the personnel carrier.

Moreover, the personnel carrier for standing occupant of the present invention has an indentation provided at the rear end of the bearing portion. The indentation can just accommodate the front wheel of another personnel carrier for standing occupant such that front and rear personnel carriers for standing occupant can be aligned in good order.

### BRIEF DESCRIPTION OF THE DRAWINGS

FIG. 1 is a perspective outline view showing the personnel carrier of the present invention.

FIG. 2 is a schematic side view showing the use state of the personnel carrier of the present invention.

FIG. 3 is a schematic view showing the personnel carriers of the present invention aligned with each other in good order.

FIG. 4 is an enlarged schematic view showing the front and the rear personnel carriers aligned with each other in good order.

### DETAILED DESCRIPTION OF PREFERRED EMBODIMENT

The objects, the technical contents and the expected effect of the present invention will become more apparent from the detailed description of the preferred embodiments in conjunction with the accompanying drawings.

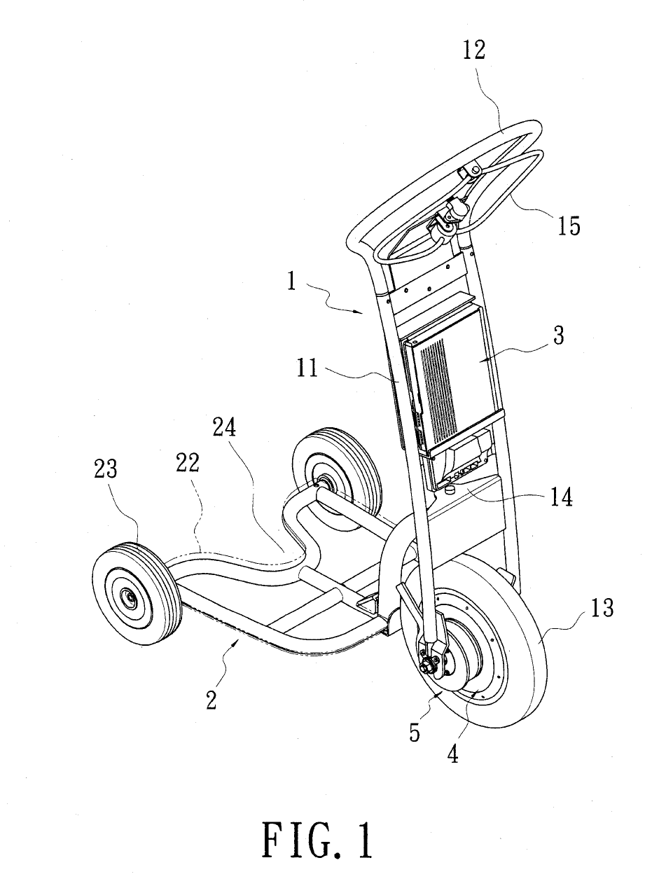

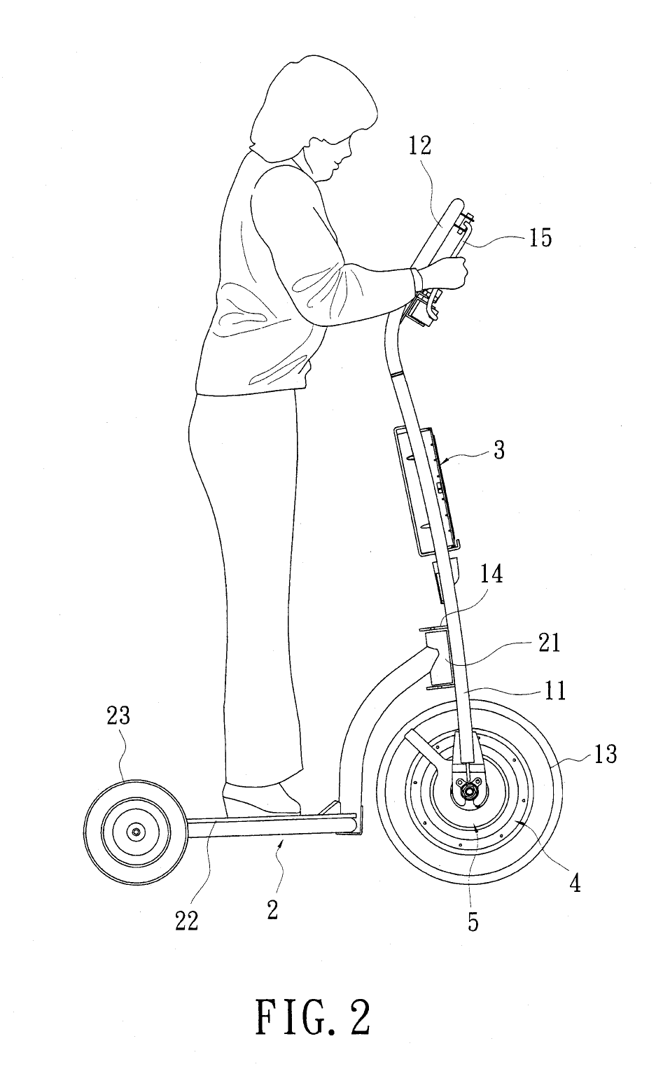

Referring to FIGS. 1 and 2, the personnel carrier for standing occupant of the present invention comprises a handle portion (1), a bearing portion (2), a power supply portion (3) and a drive portion (4).

The handle portion (1) comprises a support section (11), a steering handle (12) located on the top end of the support section (11), a front wheel (13) installed on the lower end of the support section (11). Furthermore, a first pivotal connection member (14) is provided on the support section (11) and a forward-reverse manipulation unit (15) is provided beneath the steering handle (12).

The bearing portion (2) has a second pivotal connection member (21) provided at the front end thereof, which is pivotally coupled with the first pivotal connection member (14) of the support section (11). A bearing stage (22) for standing occupant is provided on the bearing portion (2) and two rear wheels (23) are attached to the bearing portion (2).

The power supply portion (3) supplying power to whichever needs electricity such as the drive portion (4) is mounted on the support section (11) of the handle portion (1).

The drive portion (4) is disposed in the front wheel (13) for driving the front wheel (13) to rotate so as to move the personnel carrier forward or reverse. Moreover, the drive portion (4) is incorporated with an electromagnetic brake device (5) which is manipulated to control advance or stop of the personnel carrier.

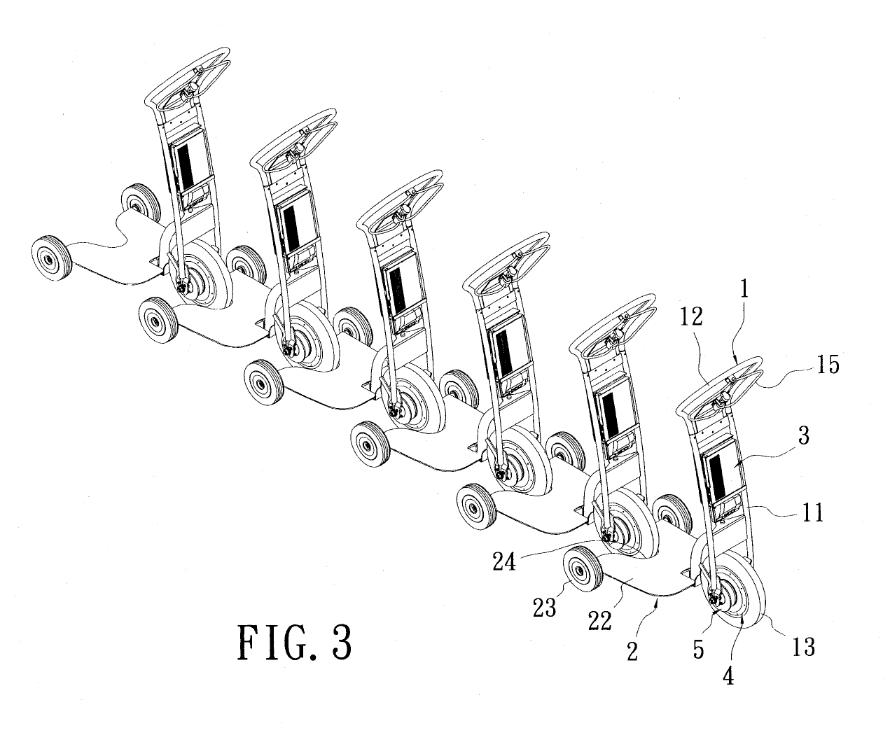

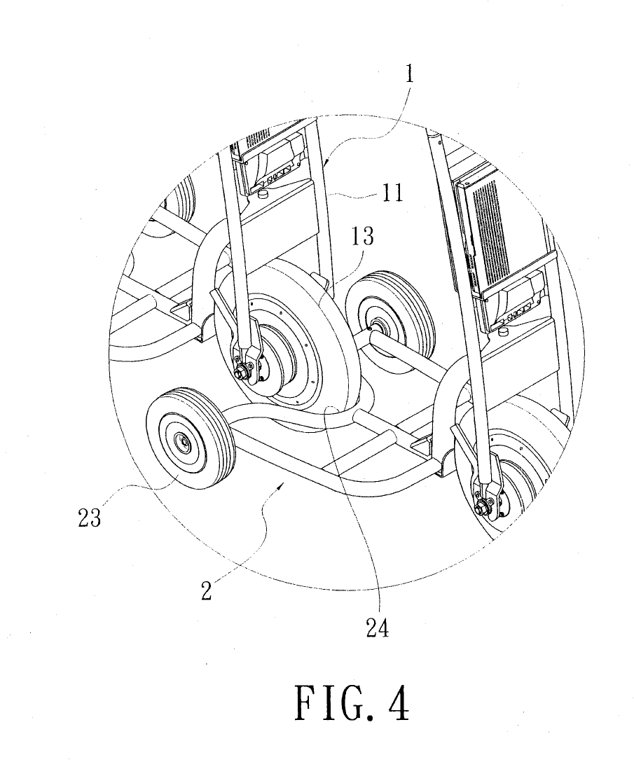

In this manner, user can stand on the bearing stage (22) of the bearing portion (2), as shown in FIGS. 2-4, and user manipulates the steering handle (12) provided on the top end of the support section (11) of the handle portion (1) to control the moving direction of the personnel carrier. Furthermore, user can manipulate the forward-reverse manipulation unit (15) provided beneath the steering handle (12) in cooperation with the drive portion (4) provided in the front wheel (13), so as to control the advance or reverse movement of the personnel carrier. When braking the personnel carrier, the electromagnetic brake device (5) is activated to stop the driving of the personnel carrier.

According to the present invention, the power supply portion (3) utilizes lithium battery as the main power source for the personnel carrier.

Moreover, the personnel carrier for standing occupant of the present invention has an indentation (24) provided at the rear end of the bearing portion (2). The indentation (24) can just accommodate the front wheel (13) of another personnel carrier for standing occupant such that the front and rear personnel carriers for standing occupant can be aligned in good order.

Based on the foregoing implementation, the personnel carrier for standing occupant of the present invention has at least the advantages set forth below.

1. As the personnel carrier of the present invention is to bear user in standing manner such that seats are no more needed. Therefore, space can be saved so as to widen the view for user.

2. The personnel carrier for standing occupant of the present invention has an indentation provided at the rear end of the bearing portion. The indentation can just accommodate the front wheel of another personnel carrier for standing occupant such that the front and rear personnel carriers for standing occupant can be aligned in good order.

The abovementioned are only a part of the implementation of the present invention, and hence are not intended to restrict the range of the present invention. Various modifications and variations can be made without departing from the spirit and scope of the present invention, as set forth in the appended claims.

Summing up above, the embodiment of the present invention can reach anticipated effect, and the specific configurations disclosed herein have yet not found in the prior art of the same category of product, even has not been opened to the public before application.

What is claimed is:

1. A personnel carrier for standing occupant, comprising a handle portion, a bearing portion, a power supply portion and a drive portion; said handle portion having a support section, a steering handle located on the top end of said support section, a front wheel installed on the lower end of the support section and a forward-reverse manipulation unit provided beneath the steering handle; said bearing portion being pivotally coupled with the handle portion and having a bearing stage for standing occupant, two rear wheels being attached to said bearing portion; said power supply portion being mounted on the support section of the handle portion for supplying power to whichever needs electricity; said drive portion incorporated with an electromagnetic brake device being disposed in the front wheel to control advance or stop of the personnel carrier.

2. The personnel carrier for standing occupant as claimed in claim 1, wherein said power supply portion utilizes lithium battery.

3. The personnel carrier for standing occupant as claimed in claim 2, wherein an indentation is provided at the rear end of said bearing portion for accommodation of the front wheel of another personnel carrier for standing occupant.

4. The personnel carrier for standing occupant as claimed in claim 1, wherein an indentation is provided at the rear end of said bearing portion for accommodation of the front wheel of another personnel carrier for standing occupant.
